(19) United States
(12) Patent Application Publication
(10) Pub. No.: US 2014/0122612 A1
(43) Pub. Date: May 1, 2014

(54) Activity-Based Discoverable Mode

(71) Applicants: Xiaomu Wu, Menlo Park, CA (US); Peter Xiu Deng, Mountain View, CA (US); Robert Mason, San Francisco, CA (US)

(72) Inventors: Xiaomu Wu, Menlo Park, CA (US); Peter Xiu Deng, Mountain View, CA (US); Robert Mason, San Francisco, CA (US)

(21) Appl. No.: 13/661,823

(22) Filed: Oct. 26, 2012

(51) Int. Cl. H04L 12/58

(52) U.S. Cl. CPC H04L 51/32
USPC 709/205

(57) ABSTRACT

In one embodiment, a method includes identifying a plurality of users that are each currently associated with a second computing device that is currently in a discoverable mode; have a commonality among them based at least in part on social-graph information associated with the users; and are currently at or near a common geo-location. The method also includes sending to each of the users a suggestion to interact with the other users based at least in part on their commonality and the users currently being at or near the common geo-location.

### TECHNICAL FIELD

This disclosure generally relates to mobile devices.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may transmit over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments place a computing system associated with a user in a “discoverable” mode and received suggest a group of other users based on the computing system associated with the other users also being in the discoverable mode. In particular embodiments, a computing system of a social-networking system may identify users that share a commonality based on social-graph information, and whose computing systems are in discoverable mode and are near or at a common geo-location. The computing system of the social-networking system may send a suggestion to interact with the identified users. For example, the computing system of the social-networking system may send a suggestion to the identified group of users to organize an impromptu group event or have group communications for updates. In particular embodiments, the computing system of the social-networking system may automatically place the computing system of the user into the discoverable mode. For example, the computing system of the social-networking system may determine users using a particular message screen of an application at the same time and location may be trying to have an online conversation with each other, and place the computing system of each user into the discoverable mode. In particular embodiments, the user may manually enter discoverable mode by entering a “discovery” code or shaking the mobile device at a pre-determined time.

### BRIEF DESCRIPTION OF THE DRAWINGS

FIG. 1 illustrates an example network environment associated with a social-networking system.

FIG. 2 illustrates an example social graph.

FIG. 3 illustrates an example mobile device.

FIG. 4 illustrates an example method for suggesting interaction between a group of users.

FIG. 5 illustrates an example method for receiving a suggestion for interaction between a group of users.

FIG. 6 illustrates an example computing system.

### DESCRIPTION OF EXAMPLE EMBODIMENTS

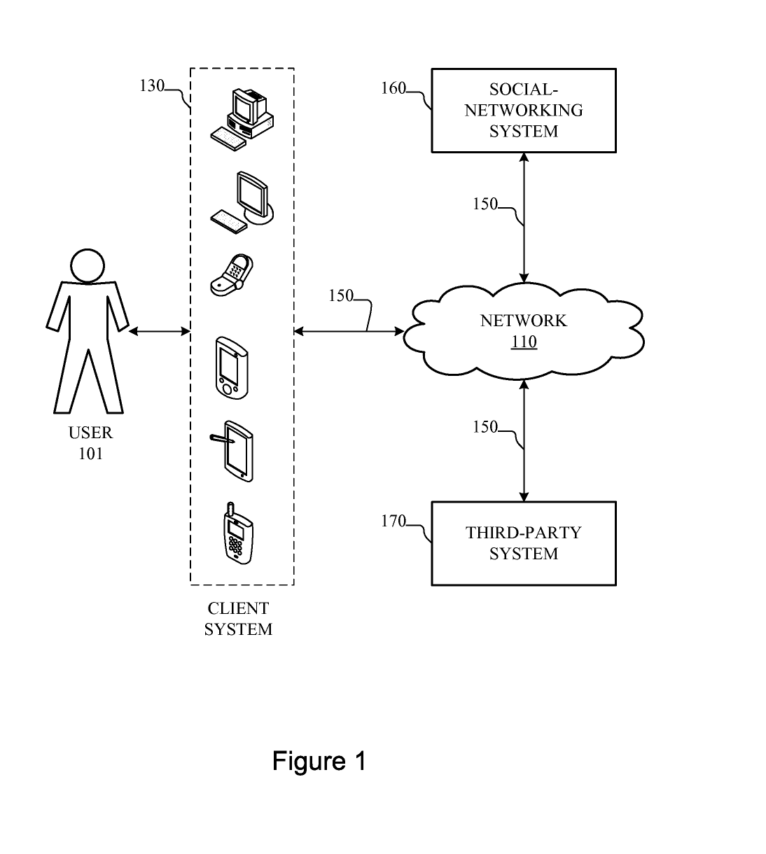

FIG. 1 illustrates an example network environment associated with a social-networking system. Network environment 100 includes a user 101, a client system 130, a social-networking system 160, and a third-party system 170 connected to each other by a network 110. Although FIG. 1 illustrates a particular arrangement of user 101, client system 130, social-networking system 160, third-party system 170, and network 110, this disclosure contemplates any suitable arrangement of user 101, client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of users 101, client systems 130, social-networking systems 160, third-party systems 170, and networks 110, this disclosure contemplates any suitable number of users 101, client systems 130, social-networking systems 160, third-party systems 170, and networks 110. As an example and not by way of limitation, network environment 100 may include multiple users 101, client system 130, social-networking systems 160, third-party systems 170, and networks 110.

In particular embodiments, user 101 may be an individual (human user), an entity (e.g., an enterprise, business, or third-party application), or a group (e.g., of individuals or entities) that interacts or communicates with or over social-networking system 160. In particular embodiments, social-networking system 160 may be a network-addressable computing system hosting an online social network. Social-networking system 160 may generate, store, receive, and transmit social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include an authorization server that allows users 101 to opt in or opt out of having their actions logged by social-networking system 160 or shared with other systems (e.g., third-party systems 170), such as, for example, by setting appropriate privacy settings. Third-party system 170 may be accessed by the other components of network environment 100 either directly or via network 110. In particular embodiments, one or more users 101 may use one or more client systems 130 to access, send data to, and receive data from social-networking system 160 or third-party system 170. Client system 130 may access social-networking system 160 or third-party system 170 directly, via network 110, or via a third-party system. As an example and not by way of limitation, client system 130 may access third-party system 170 via social-networking system 160. Client system 130 may be any suitable computing device, such as for example, a personal computer, or a mobile device including a laptop computer, a mobile telephone, a smartphone, or a tablet computer.

Client system 130 associated with user 101 may be placed into a “discoverable” mode by social-networking system 160 or third-party system 170. As an example and not by way of limitation, the discoverable mode may be considered a pairing process that brings together client systems 130 associated with users 101 through social-networking system 160 or third-party system 170. In particular embodiments, placing client system 130 into discoverable mode may be initiated through particular activity performed by users 101 on client system 130. As an example and not by way of limitation, client system 130 associated with user 101 may be automatically placed into the discoverable mode by social-networking system 160 or manually by user 101 through client device 130, as described below. Placing client system 130 associated with user 101 into the discoverable mode may initiate a search by a server of social-networking system 160 or third-party system 170 for client systems 130 associated with other users that are currently in discoverable mode. In particular embodiments, a server of social-networking system 160 or third-party system 170 may determine membership into one or more groups that include user 101 and one or more of the other users 101 that are in the discoverable mode. As an example and not by way of limitation, the membership into one or more of the groups may be determined at least in part by a commonality between the other users and user 101. As described below, the commonality may be based at least in part on social-graph information and the user 101 and the other users may be at or near a common geo-location.

Social-networking system 160 or third-party system 170 may rank the commonality between user 101 and the other users. In particular embodiments, the ranking may be based at least in part on a spatial proximity of the other users to user 101 or a “closeness” of a relationship of the other users relative to user 101 based at least in part on social-graph information, as described below. Social-networking system 160 or third-party system 170 may provide user 101 a suggestion to interact with one or more groups of other users with client systems 130 in discoverable mode that may be relevant to user 101. As an example and not by way of limitation, members of a group of users with client systems 130 in the discoverable mode may organize an impromptu event or have communication between members of the group through social-networking system 160 based at least in part on their commonality and being at or near a common geo-location.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example WI-FI or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

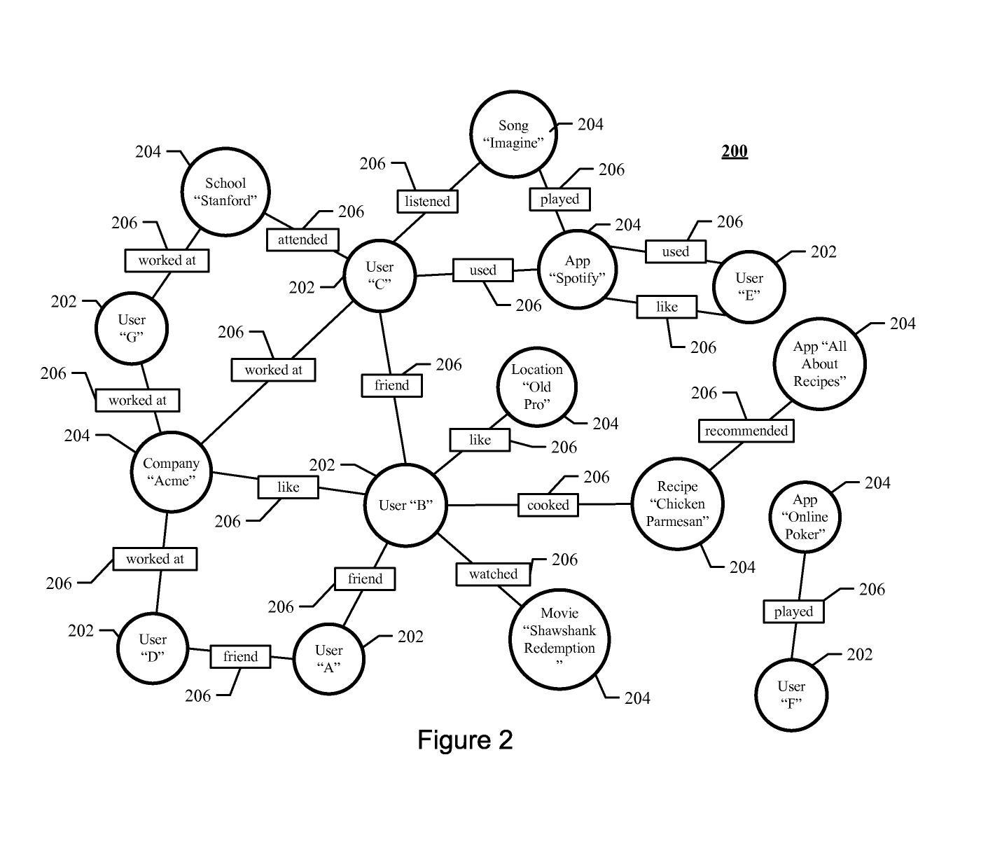

FIG. 2 illustrates an example social graph. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to transmit to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may transmit a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check-in” icon (such as, for example, a clickable “check-in” icon) or a selectable “add to favorites” icon. Similarly, after a user clicks these icons, social-networking system 160 may create a “favorite” edge or a “check-in” edge in response to a user's action corresponding to a respective action. As another example and not by way of limitation, a user (user “C”) may listen to a particular song (“Ramble On”) using a particular application (SPOTIFY, which is an online streaming music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to transmit to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

As described above, the determination of membership into one or more groups of other users with client devices in the discoverable mode may be based on a commonality between the users. In particular embodiments, the commonality may be based at least in part on information of social graph 200 associated with the user of the client device (e.g. user “C”). As an example and not by way of limitation, the social-networking system may determine a commonality between user nodes 202 directly connected to the user of the client device (e.g. user “B” and user “C”) by an edge 206 representing a relationship between user nodes 202, while the social-networking system may determine users that are not connected by an edge 206, such as for example user “A” and user “C” may not have a direct relationship. As another example, the social-networking system may determine a commonality between users based on each having an edge 206 to a common concept node 204, such as for example both user “C” and user “E” use SPOTIFY. In particular embodiments, the user (e.g. user “C”) or the social-networking system may rank commonalities. As an example and not by way of limitation, a commonality defined by an edge 206 to a common concept node 204, such as for example song “Imagine” may be ranked higher than a commonality defined by a relationship edge 206 (e.g. “friend”) between user nodes 202, such as for example user “C” and user “B”. Although this disclosure illustrates and describes particular commonalities between users based on particular information of a particular social graph, this disclosure contemplates any suitable commonality based on any suitable information of any suitable social graph.

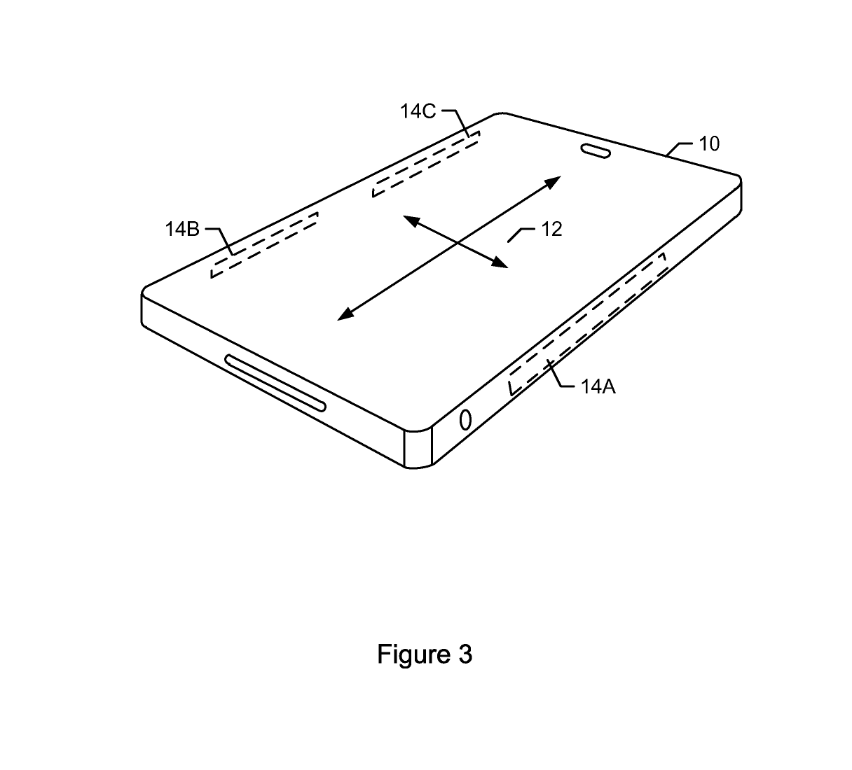

FIG. 3 illustrates an example mobile device. In particular embodiments, the client system may be a mobile device 10 as described above. This disclosure contemplates mobile device 10 taking any suitable physical form. In particular embodiments, mobile device 10 may be a computing system as described below. As example and not by way of limitation, mobile device 10 may be a single-board computer system (SBC) (such as, for example, a computer-on-module (COM) or system-on-module (SOM)), a laptop or notebook computer system, a mobile telephone, a smartphone, a personal digital assistant (PDA), a tablet computer system, or a combination of two or more of these. In particular embodiments, mobile device 10 may have a touch sensor 12 as an input component. In the example of FIG. 3, touch sensor 12 is incorporated on a front surface of mobile device 10. In the case of capacitive touch sensors, there may be two types of electrodes: transmitting and receiving. These electrodes may be connected to a controller designed to drive the transmitting electrodes with electrical pulses and measure the changes in capacitance from the receiving electrodes caused by a touch or proximity input. In the example of FIG. 3, one or more antennae 14A-B may be incorporated into one or more sides of mobile device 10. Antennae 14A-B are components that convert electric current into radio waves, and vice versa. During transmission of signals, a transmitter applies an oscillating radio frequency (RF) electric current to terminals of antenna 14A-B, and antenna 14A-B radiates the energy of the applied the current as electromagnetic (EM) waves. During reception of signals, antennae 14A-B convert the power of an incoming EM wave into a voltage at the terminals of antennae 14A-B. The voltage may be transmitted to a receiver for amplification.

In particular embodiments, the social-networking system or the third-party system may poll or “ping” mobile device 10 using a activation signal to obtain location information. As an example and not by way of limitation, the social-networking system may poll the application of mobile device 10 for location data by sending the activation signal activate the location service of mobile device 10. The activation signal may be transmitted using a wireless communication protocol such as for example, WI-FI or third-generation mobile telecommunications (3G) and received by mobile device 10 through one or more antennae 14A-B. In particular embodiments, the location service of mobile device 10 may use one or more methods of location determination, such as for example, using the location of one or more cellular towers, crowd-sourced location information associated with a WI-FI hotspot, or the global-positioning system (GPS) function of mobile device 10. As described above, the social-networking system may identify mobile device 10 associated with each user currently in discoverable mode based in part on the location data provided by mobile device 10. As an example and not by way of limitation, the social-networking system may identify one or more users based at least in part on each user being at or near a common geo-location as determined by the location data of mobile device 10 associated with each user. In particular embodiments, the common geo-location may include a pre-determined area encompassing the common geo-location, a building associated with the common geo-location, or a site associated with the common geo-location. Although this disclosure describes particular geo-locations, this disclosure contemplates any suitable geo-location.

In particular embodiments, mobile device 10 may be automatically and without manual input be placed into the discoverable mode by analyzing activity of the user on mobile device 10. As an example and not by way of limitation, the social-networking system may place mobile device 10 into discoverable mode based on substantially the same activity being performed on the same application at substantially the same time. As a further example, the social-networking system may determine the user of mobile device 10 and another user using a message feature of a particular application at substantially the same time and location may be having an online conversation with each other. The social-networking system may place mobile device 10 associated with these users into the discoverable mode. In particular embodiments, the user of mobile device 10 may manually place mobile device 10 into the discoverable mode. As an example and not by way of limitation, the user may place associated mobile device 10 into the discoverable mode by providing a pre-determined code to a particular application on mobile device 10 using touch sensor 12. In particular embodiments, mobile device 10 may send a signal to the social-networking system though movement captured using one or more sensors of mobile device 10. As an example and not by way of limitation, the user may shake mobile device 10 at a particular time which is captured by an accelerometer of mobile device 10. Mobile device 10 may send a signal to the social-networking system in response to the detected input and the social-networking system may place mobile device 10 associated with the user into the discoverable mode. Although this disclosure describes particular methods of placing a mobile device into the discoverable mode, this disclosure contemplates any suitable methods of placing a mobile device into the discoverable mode.

As described above, the social-networking system may send a suggestion to interact with one or more other users. In particular embodiments, the suggestion may be displayed on the display of mobile device 10. As an example and not by way of limitation, a suggestion to organize an impromptu event, such as for example, a meal at a particular restaurant, may be sent to mobile devices 10 in the discoverable mode and within a pre-determined distance from the particular restaurant, where each of the users indicated they “liked” the particular restaurant in the social-networking system. As another example, the social-networking system may send a suggestion for a group communication between users of mobile device 10 that are in the discoverable mode that are at a particular mall, where each of the users are “friends” with each other on the social-networking system. Although this disclosure describes particular suggestions for particular interactions between users, this disclosure contemplates any suitable suggestion for any suitable interaction between users.

In particular embodiments, membership of the one or more groups of users may be provided to the user through a user-interface (UI) session displayed on the display of mobile device 10. As an example and not by way of limitation, the social-networking system may display a facepile of the membership on the display of mobile device 10. As described above, the membership of each of one or more groups may based on a commonality among the users associated with mobile devices 10 currently in the discoverable mode and mobile devices 10 associated with the users being at or near a common geo-location. In particular embodiments, the user may elect to interact with a particular group by providing input through touch sensor 12 of mobile device 10.

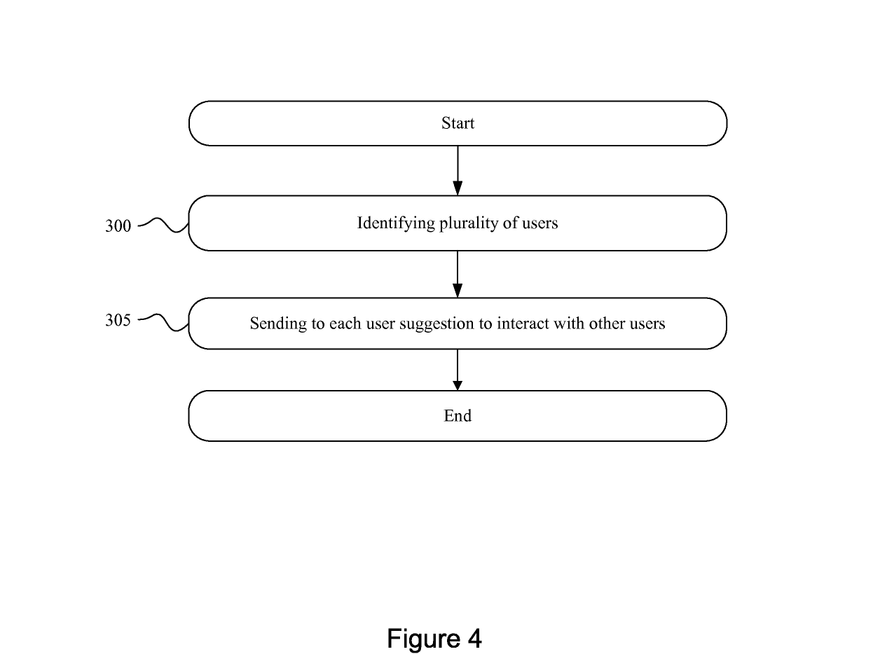

FIG. 4 illustrates an example method for suggesting interaction between a group of users. The method may start at step 300, where a first computing device identifies a plurality of users. In particular embodiments, each of the users are currently associated with a second computing device that is currently in the discoverable mode. In addition, each of the users have a commonality among them that is based at least in part on social-graph information associated with the users and the users are currently at or near a common geo-location. At step 305, the first computing device sends to each user a suggestion to interact with the other users, at which point the method may end. In particular embodiments, sending the suggestion is based at least in part on the commonality between the users and being near or at the common geo-location. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates particular components carrying out particular steps of the method of FIG. 4, this disclosure contemplates any suitable combination of any suitable components carrying out any suitable steps of the method of FIG. 4.

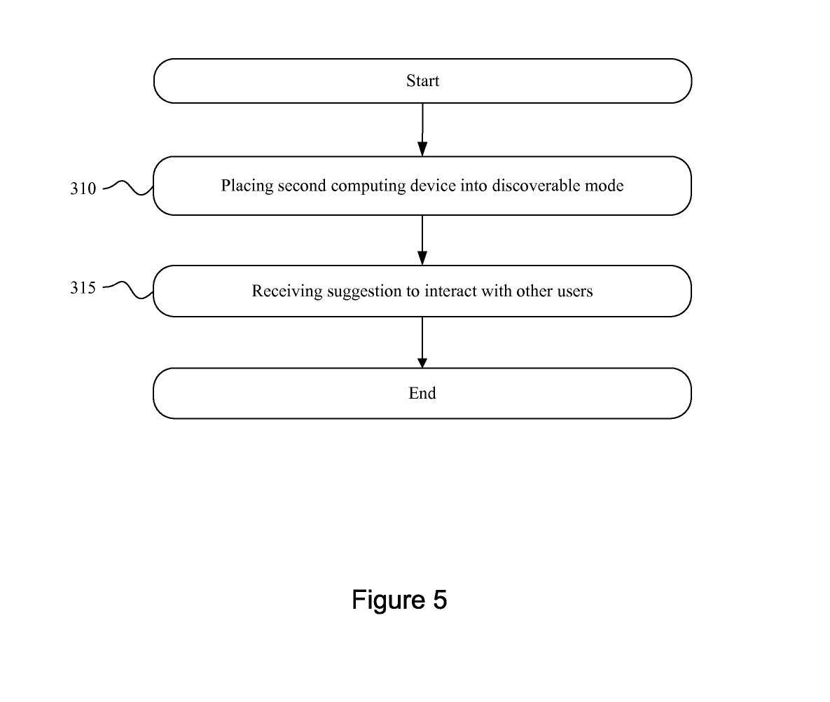

FIG. 5 illustrates an example method for receiving a suggestion for interaction between a group of users. The method may start at step 310, where a second computing device associated with a user is placed into a discoverable mode. In particular embodiments, the placement of the second computing device into the discoverable mode initiates a search by a first computing device for other second computing devices associated with other users currently in the discoverable mode. At step 315, the second computing device receives a suggestion to interact with the other users, at which point the method may end. In particular embodiments, the other users are identified by the first computing device based at least in part on social-graph information and being at or near a common geo-location. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates particular components carrying out particular steps of the method of FIG. 5, this disclosure contemplates any suitable combination of any suitable components carrying out any suitable steps of the method of FIG. 5.

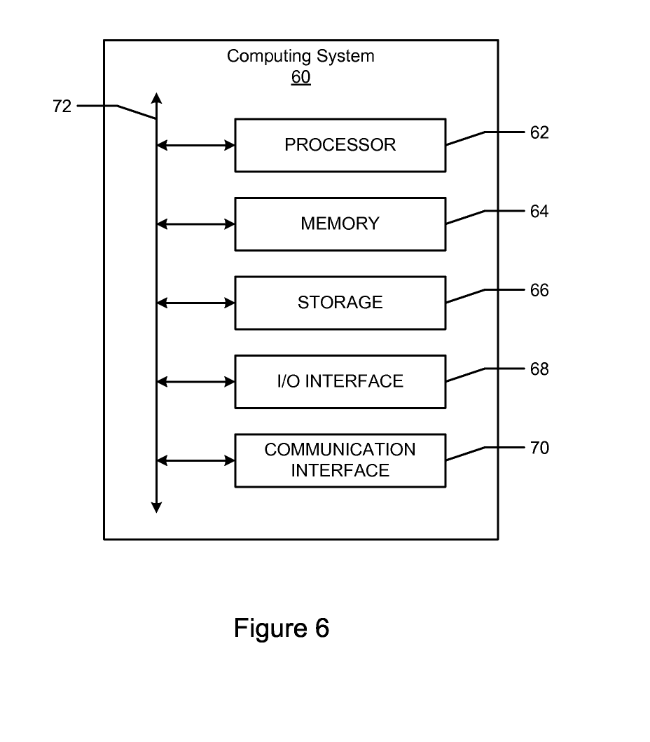

FIG. 6 illustrates example computing system. In particular embodiments, one or more computer systems 60 perform one or more steps of one or more methods described or illustrated herein. In particular embodiments, one or more computer systems 60 provide functionality described or illustrated herein. In particular embodiments, software running on one or more computer systems 60 performs one or more steps of one or more methods described or illustrated herein or provides functionality described or illustrated herein. Particular embodiments include one or more portions of one or more computer systems 60. Herein, reference to a computer system may encompass a computing device, where appropriate. Moreover, reference to a computer system may encompass one or more computer systems, where appropriate.

This disclosure contemplates any suitable number of computer systems 60. This disclosure contemplates computer system 60 taking any suitable physical form. As example and not by way of limitation, computer system 60 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 60 may include one or more computer systems 60; be unitary or distributed; span multiple locations; span multiple machines; span multiple data centers; or reside in a cloud, which may include one or more cloud components in one or more networks. Where appropriate, one or more computer systems 60 may perform without substantial spatial or temporal limitation one or more steps of one or more methods described or illustrated herein. As an example and not by way of limitation, one or more computer systems 60 may perform in real time or in batch mode one or more steps of one or more methods described or illustrated herein. One or more computer systems 60 may perform at different times or at different locations one or more steps of one or more methods described or illustrated herein, where appropriate.

In particular embodiments, computer system 60 includes a processor 62, memory 64, storage 66, an input/output (I/O) interface 68, a communication interface 70, and a bus 72. Although this disclosure describes and illustrates a particular computer system having a particular number of particular components in a particular arrangement, this disclosure contemplates any suitable computer system having any suitable number of any suitable components in any suitable arrangement.

In particular embodiments, processor 62 includes hardware for executing instructions, such as those making up a computer program. As an example and not by way of limitation, to execute instructions, processor 62 may retrieve (or fetch) the instructions from an internal register, an internal cache, memory 64, or storage 66; decode and execute them; and then write one or more results to an internal register, an internal cache, memory 64, or storage 66. In particular embodiments, processor 62 may include one or more internal caches for data, instructions, or addresses. This disclosure contemplates processor 62 including any suitable number of any suitable internal caches, where appropriate. As an example and not by way of limitation, processor 62 may include one or more instruction caches, one or more data caches, and one or more translation lookaside buffers (TLBs). Instructions in the instruction caches may be copies of instructions in memory 64 or storage 66, and the instruction caches may speed up retrieval of those instructions by processor 62. Data in the data caches may be copies of data in memory 64 or storage 66 for instructions executing at processor 62 to operate on; the results of previous instructions executed at processor 62 for access by subsequent instructions executing at processor 62 or for writing to memory 64 or storage 66; or other suitable data. The data caches may speed up read or write operations by processor 62. The TLBs may speed up virtual-address translation for processor 62. In particular embodiments, processor 62 may include one or more internal registers for data, instructions, or addresses. This disclosure contemplates processor 62 including any suitable number of any suitable internal registers, where appropriate. Where appropriate, processor 62 may include one or more arithmetic logic units (ALUs); be a multi-core processor; or include one or more processors 62. Although this disclosure describes and illustrates a particular processor, this disclosure contemplates any suitable processor.

In particular embodiments, memory 64 includes main memory for storing instructions for processor 62 to execute or data for processor 62 to operate on. As an example and not by way of limitation, computer system 60 may load instructions from storage 66 or another source (such as, for example, another computer system 60) to memory 64. Processor 62 may then load the instructions from memory 64 to an internal register or internal cache. To execute the instructions, processor 62 may retrieve the instructions from the internal register or internal cache and decode them. During or after execution of the instructions, processor 62 may write one or more results (which may be intermediate or final results) to the internal register or internal cache. Processor 62 may then write one or more of those results to memory 64. In particular embodiments, processor 62 executes only instructions in one or more internal registers or internal caches or in memory 64 (as opposed to storage 66 or elsewhere) and operates only on data in one or more internal registers or internal caches or in memory 64 (as opposed to storage 66 or elsewhere). One or more memory buses (which may each include an address bus and a data bus) may couple processor 62 to memory 64. Bus 72 may include one or more memory buses, as described below. In particular embodiments, one or more memory management units (MMUs) reside between processor 62 and memory 64 and facilitate accesses to memory 64 requested by processor 62. In particular embodiments, memory 64 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 64 may include one or more memories 64, where appropriate. Although this disclosure describes and illustrates particular memory, this disclosure contemplates any suitable memory.

In particular embodiments, storage 66 includes mass storage for data or instructions. As an example and not by way of limitation, storage 66 may include a hard disk drive (HDD), a floppy disk drive, flash memory, an optical disc, a magneto-optical disc, magnetic tape, or a Universal Serial Bus (USB) drive or a combination of two or more of these. Storage 66 may include removable or non-removable (or fixed) media, where appropriate. Storage 66 may be internal or external to computer system 60, where appropriate. In particular embodiments, storage 66 is non-volatile, solid-state memory. In particular embodiments, storage 66 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 66 taking any suitable physical form. Storage 66 may include one or more storage control units facilitating communication between processor 62 and storage 66, where appropriate. Where appropriate, storage 66 may include one or more storages 66. Although this disclosure describes and illustrates particular storage, this disclosure contemplates any suitable storage.

In particular embodiments, I/O interface 68 includes hardware, software, or both providing one or more interfaces for communication between computer system 60 and one or more I/O devices. Computer system 60 may include one or more of these I/O devices, where appropriate. One or more of these I/O devices may enable communication between a person and computer system 60. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 68 for them. Where appropriate, I/O interface 68 may include one or more device or software drivers enabling processor 62 to drive one or more of these I/O devices. I/O interface 68 may include one or more I/O interfaces 68, where appropriate. Although this disclosure describes and illustrates a particular I/O interface, this disclosure contemplates any suitable I/O interface.

In particular embodiments, communication interface 70 includes hardware, software, or both providing one or more interfaces for communication (such as for example, packet-based communication) between computer system 60 and one or more other computer systems 60 or one or more networks. As an example and not by way of limitation, communication interface 70 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 70 for it. As an example and not by way of limitation, computer system 60 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 60 may communicate with a wireless PAN (WPAN) (such as for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 60 may include any suitable communication interface 70 for any of these networks, where appropriate. Communication interface 70 may include one or more communication interfaces 70, where appropriate. Although this disclosure describes and illustrates a particular communication interface, this disclosure contemplates any suitable communication interface.

In particular embodiments, bus 72 includes hardware, software, or both coupling components of computer system 60 to each other. As an example and not by way of limitation, bus 72 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 72 may include one or more buses 72, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a first computing device, identifying a plurality of users that:
are each currently associated with a second computing device that is currently in a discoverable mode;
have a commonality among them based at least in part on social-graph information associated with the users; and
are currently at or near a common geo-location; and
by the first computing device, sending to each of the users a suggestion to interact with one or more other ones of the users based at least in part on their commonality and them currently being at or near the common geo-location.

2. The method of claim 1, further comprising initiating a search for one or more other ones of the users in the discoverable mode in response to receiving a signal from the second computing device based on activity performed by one or more of the users on the second computing device, entering a code on the second computing device, or performing a motion with the second computing device at a pre-determined time.

3. The method of claim 2, wherein receiving a signal from the second computing device based on activity performed by one or more of the users on the second computing device comprising determining whether each of the users are performing substantially the same activity on the second computing device.

4. The method of claim 3, wherein the determination comprises determining whether each of the users are using a particular application executed on the second computing device at substantially the same time.

5. The method of claim 1, wherein the social-graph information comprises an interest common to the plurality of users or a relationship between the plurality of users.

6. The method of claim 1, wherein the common geo-location comprises a pre-determined area encompassing the common geo-location, a building associated with the common geo-location, or a site associated with the common geo-location.

7. The method of claim 1, wherein the interaction comprises organizing an event or communicating a message to the plurality of users.

8. One or more computer-readable non-transitory storage media embodying logic configured when executed to:
identify a plurality of users that:
are each currently associated with a second computing device that is currently in a discoverable mode;
have a commonality among them based at least in part on social-graph information associated with the users; and
are currently at or near a common geo-location; and
send to each of the users a suggestion to interact with one or more other ones of the users based at least in part on their commonality and them currently being at or near the common geo-location.

9. The media of claim 8, wherein the logic is further configured to initiate a search for one or more other ones of the users in the discoverable mode in response to receiving a signal from the second computing device based on activity performed by one or more of the users on the second computing device, entering a code on the second computing device, or performing a motion with the second computing device at a pre-determined time.

10. The media of claim 9, wherein the logic is further configured to determine whether each of the users are performing substantially the same activity on the second computing device.

11. The media of claim 10, wherein the logic is further configured to determine whether each of the users are using a particular application executed on the second computing device at substantially the same time.

12. The media of claim 8, wherein the social-graph information comprises an interest common to the plurality of users or a relationship between the plurality of users.

13. The media of claim 8, wherein the common geo-location comprises a pre-determined area encompassing the common geo-location, a building associated with the common geo-location, or a site associated with the common geo-location.

14. The media of claim 8, wherein the interaction comprises organizing an event or communicating a message to the plurality of users.

15. A method comprising:
placing a second computing device associated with a user into a discoverable mode, the placement of the second computing device into the discoverable mode initiating a search by a first computing device for one or more other second computing devices associated with one or more other users currently in the discoverable mode; and
by the second computing device, receiving a suggestion to interact with one or more other users, the other users being identified by the first computing device based at least in part on a commonality among each of the users based at least in part on social-graph information associated with the users and each of the users currently being at or near the common geo-location.

16. The method of claim 15, further comprising sending a signal based on activity performed by each of the users on the associated second computing device, entering a code on the associated second computing device, or performing a motion with the associated second computing device at a pre-determined time, the sending of the signal initiating the search by the first computing device for one or more other ones of the users in the discoverable mode.

17. The method of claim 16, wherein sending the signal based on activity performed by each of the users on the associated second computing device comprising determining whether each of the users are performing substantially the same activity on the associated second computing device.

18. The method of claim 15, wherein the social-graph information comprises an interest common to the plurality of users or a relationship between the plurality of users.

19. The method of claim 15, wherein the common geo-location comprises a pre-determined area encompassing the common geo-location, a building associated with the common geo-location, or a site associated with the common geo-location.

20. The method of claim 15, wherein the interaction comprises organizing an event or communicating a message to the plurality of users.
